(19) United States
(12) Patent Application Publication
(10) Pub. No.: US 2005/0124327 A1
(43) Pub. Date: Jun. 9, 2005

(54) Method for managing multiple calls

(75) Inventor: Ha-Young Lee, Ichon-shi (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Ichon-shi (KR)

(21) Appl. No.: 11/002,238

(22) Filed: Dec. 3, 2004

(30) Foreign Application Priority Data
Dec. 3, 2003 (KP) 10-2003-0087164

(51) Int. Cl. H04B 7/00

(52) U.S. Cl. 455/414.1; 455/415

(57) ABSTRACT

A method for managing multiples calls from multiple callers by receiving a flash message having call state information from a base station and displaying call state information to a user is disclosed. The method includes the steps of: a) connecting a first mobile terminal and a second mobile terminal as a first call connection; b) determining whether there is a request for a second call connection from a third mobile terminal; c) determining whether a call-selection button is activated and continuously maintaining the first call connection if the call connection button is not activated; d) at the first mobile terminal, receiving a flash message having call state information when the call-selection button of the first mobile terminal is activated; and e) at the first mobile terminal, providing information of mobile terminals currently connected to the first mobile terminal by analyzing the call state information and repeatedly performing the step c).

### FIELD OF THE INVENTION

The present invention relates to a method for managing multiple calls; and, more particularly, to a method for managing multiples calls from multiple callers by receiving a flash message having call state information from a base station and displaying call state information to a user.

### DESCRIPTION OF RELATED ARTS

Recently, a mobile phone commonly includes a call-waiting feature. The call-waiting feature provides a method for receiving new incoming call from a third caller during a first caller and a second caller talks over the mobile phone. That is, when the first caller receives the new call from the third caller during the first caller and the second caller talks over the mobile phone, a current call from the second caller is putted in a waiting state and the new call is connected to the first caller. After talking to the third caller, the first caller can be reconnected to the third caller who was temporarily on the waiting state.

FIG. 1 is a flowchart illustrating a conventional method for performing a call-waiting feature in accordance with a prior art.

As shown, a first user of a mobile phone receives a current call from a second user and the first user and the second user talks over the current call of the mobile phone at step S101.

It determines whether a new call is received from a third user in a predetermined times at step S102.

In a case there is no new call from the third user, operation of the step S101 is performed again.

In a case there is new call from the third user, receiving of new call is noticed to the first user at step S103.

If the first user wants to talk to the third user, the current call is putted into a waiting state by selecting appropriate menu and the first user talks with the third user over the new call by connecting the third user to the first user at step S104.

Generally, the first user uses a send key to select the new call for talking to the third user.

According to the conventional method, there is no information from a system and thus a telephone number of the second caller is stored for displaying currently talking person to the first user and a telephone number of the third caller is displayed. After talking to the third caller, the first caller clicks the SEND button for re-connecting to the second caller and the stored telephone number is displayed.

However, the first caller cannot determine whether the second caller hangs up the current call which was in the waiting state although the first caller clicks the SEND button and the stored telephone number of the second caller is displayed to the first caller.

### SUMMARY OF THE INVENTION

It is, therefore, an object of the present invention to provide for a managing multi-call method for providing detailed information of multi-calls to a user by receiving user information from a network system to a mobile phone.

It is another object of the present invention to provide for a managing multi-call method for providing detailed information of multi-calls to a user by generating a waiting call information message (WC) to include a flash message having call state information.

It is still another object of the present invention to provide for a managing multi-call method for providing detailed information of multi-call to a user by generating a call end information message to includes call state information of callers in a waiting state.

In accordance with an aspect of the present invention, there is provided a method for managing to receive multiples calls from multiple mobile terminals used in a network terminal including a plurality of the mobile terminals and a base station, the method including the steps of: a) connecting a first mobile terminal and a second mobile terminal as a first call connection; b) determining whether there is a request for a second call connection from a third mobile terminal; c) determining whether a call-selection button is activated when the second call connection is requested from the third mobile terminal and continuously maintaining the first call connection if the call connection button is not activated; d) at the first mobile terminal, receiving a flash message having call state information from the base station when the call-selection button of the first mobile terminal is activated; and e) at the first mobile terminal, providing information of mobile terminals currently connected to the first mobile terminal by analyzing the call state information and repeatedly performing the step c).

In accordance with an aspect of the present invention, there is also provided a method for managing multiple calls in a mobile terminal, the method including the steps of: a) requesting a second call connection while a first call connection is established; and b) receiving a call state information when the first call connection is transformed to the second call connection, wherein the call state information is a plurality of call identification information about the first call connection and the second call connection.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a flowchart illustrating a conventional method for performing a call-waiting feature in accordance with a prior art;

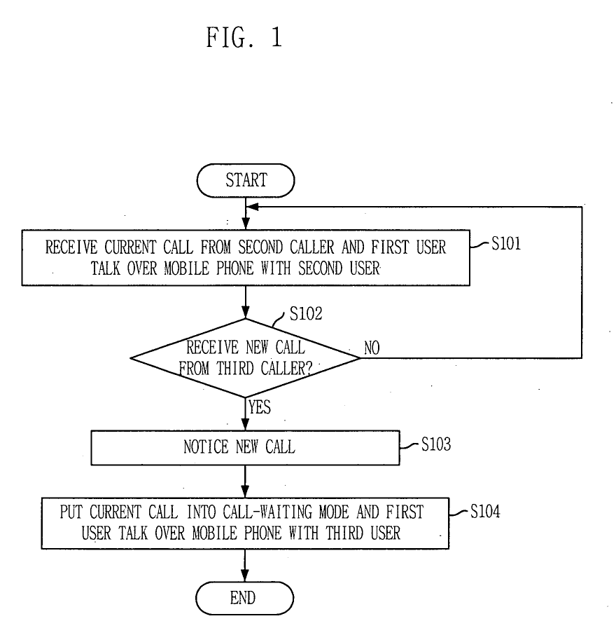

FIG. 2 is a diagram depicting a code division multiple access (CDMA) system in which a method for managing multiple calls of the present invention is implemented; and

FIG. 3 is a flowchart illustrating a method for managing multiple calls by receiving a flash message having call state information from a base station and displaying the call state information in accordance with a preferred embodiment of the present invention.

### DETAILED DESCRIPTION OF THE INVENTION

Hereinafter, a method for managing multiples calls by receiving a flash message including call stat information from a base station and displaying the call stat information to a display unit of a mobile terminal in accordance with a preferred embodiment of the present invention will be described in detail with reference to the accompanying drawings.

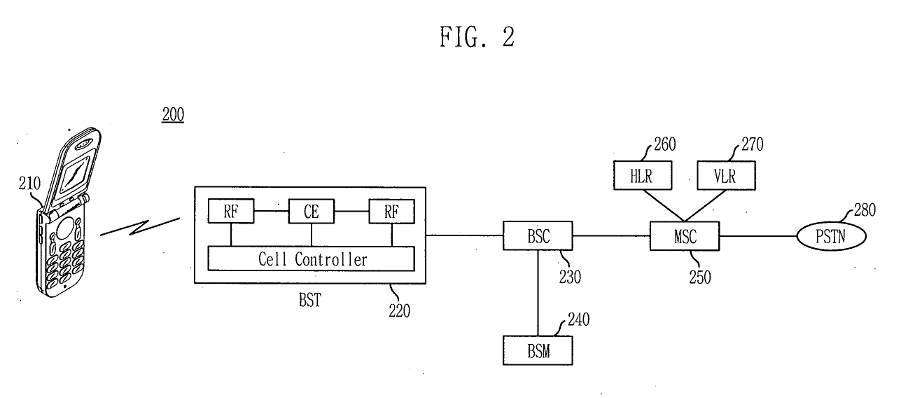

FIG. 2 is a diagram depicting a code division multiple access (CDMA) system in which a method for managing multiple calls of the present invention is implemented.

The CDMA system 200 includes a mobile terminal 210, a base transceiver station(BTS) 220, a base station controller (BSC) 230, a base station manager (BSM) 240, a mobile switching center (MSC) 250, a home location register (HLR) 260, a visitor location register (VLR) 270 and a public switched telephone network (PSTN) 280.

The mobile terminal 210 receives and transmits a signal from/to the BTS 220 while the mobile station 210 is moving for using a voice service or a packet data service. That is, the mobile terminal 210 includes a wireless transceiver, an antenna and a controller for performing various functions in order to receive a call from another mobile terminal, make a call to another mobile terminal or receiving multimedia data through the Internet.

The base transceiver station (BTS) 220 receives and transmits a signal from/to the mobile terminal 210 through a wireless communication link for providing the voice service and the packet data service. The CDMA system may include a plurality of base transceiver stations. The BTS 220 includes a cell controller, a cell element (CE) and a radio frequency transceiver (RF). The cell controller controls operations of the BTS 220. The cell controller includes a memory for storing programs and a processing circuitry for performing operation program in order to communicate with the BSC 230. The cell controller also controls operations of the channel element (CE) including main channel elements performing bi-directional communication through a forward channel and a reverse channel. The forward channel is a channel for propagating an outbound signal from the base station to the mobile terminal and the reverse channel is a channel for propagating an inbound signal from the mobile terminal to the base station. Also, the channel element (CE) and the mobile terminal in corresponding cell are operated according to a code division multiple access (CDMA) protocol. The BTS 220 also includes an antenna (not shown) for transmitting the outbound signal from the radio frequency transceiver to the mobile terminal located in a coverage of the BTS 220 and for transmitting the inbound signal from the mobile terminal to the radio frequency transceiver in a coverage of the BTS 220.

The base station controller (BSC) 230 is connected to the BTS 220 and controls wireless communication resources within a predetermined cell in a wireless communication network. The BSC 230 and the BSC 230 transmit a signal of voice and data from the mobile terminal 210 to the public switched telephone network (PSTN) 280 through the mobile switching center (MSC) 250.

The base station manager (BSM) 240 maintenances the base station transceiver 220 and the base station controller 230.

The mobile switching center (MSC) 250 provides a connection between the base station controller (BSC) 230 to public switched telephone network (PSTN) 280. The MSC 250 manages processes of a call-in and a call-out in BTS 220 for increasing efficiency and establishes the connection between the BTS 220 and the PSTN 280 through a trunk line. The MSC 250 also collects charging information for establishing and maintaining the connection between the BSC 230 and the PSTN 280. Furthermore, the MSC 250 registers a location of the mobile terminal by cooperating with the home location register (HLR) 260 and the visitor location register (VLR) 270.

As mentioned above, the mobile terminal 210, the BTS 220, the BSC 230 and the MSC 250 are connected each others through a communication line or a data link in the CDMA system 200. In the CDMA system 200, a pair of wireless transceiving channels is used for making a call connection between the mobile terminal 210 and the BTS 220 but the wireless transceiving channels are not fixed to a predetermined frequency channel. It is possible to use any other frequency channels allocated in a predetermined cell since the channel may be changed to another frequency channels when the mobile terminal 210 is moving in the predetermined cell.

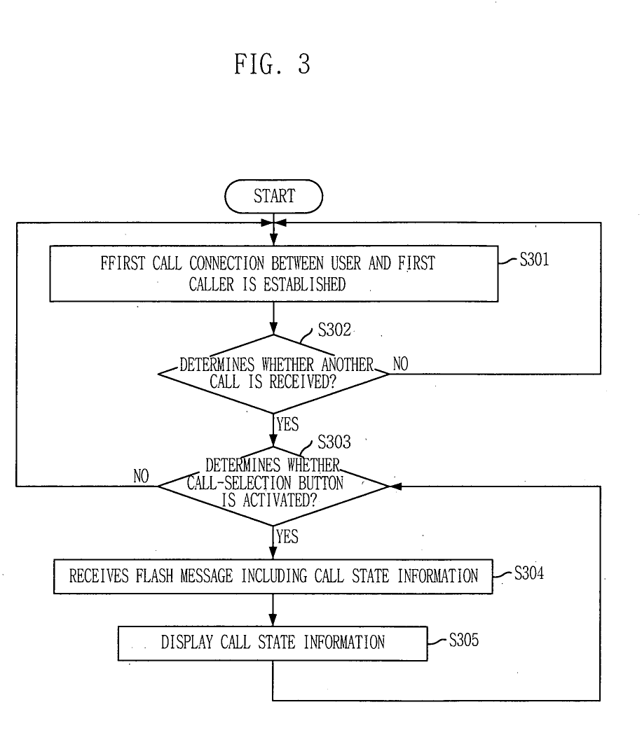

FIG. 3 is a flowchart illustrating a method for managing multiple calls by receiving a flash message having call state information from a base station and displaying the call state information in accordance with a preferred embodiment of the present invention.

As shown in FIG. 3, when a mobile terminal receives a call from a first caller, the mobile terminal establishes a first call connection to the first caller and a user of the mobile terminal talks over the mobile terminal with a first caller by maintaining the first call connection at step S301.

During maintaining the first call connection, the mobile terminal determines whether there is another call received from a second caller at a predetermined time intervals at step S302.

If there are not any other calls from the second caller, the first call connection is maintained and the user and the first caller continuously talks over the mobile phone.

If there is another call received from the second caller, the mobile phone determines whether a call-selection button of the mobile phone is activated for receiving another call from the second caller at step S303.

If the call-selection button is not activated, the first call connection is maintained and the user of the mobile terminal continuously talks over the mobile phone with the first caller.

If the call-selection button is activated, the mobile phone receives a flash message including call state information from a base station transceiver at step S304.

At the base station transceiver, the flash message including call state information is generated and transmitted the generated flash message to the mobile terminal by generating a Waiting Call Information Message (WCI) and inserting the generated flash message into the generated WCI as like as transmitting an Alert With Information Message (AWI) including calling party information. The call state information of the flash message includes information about call state of corresponding caller such as a mobile terminal number, a state of call connection with the caller representing a busy, an activate state, a deactivate state and a hold state.

As a reference, a format of a conventional AWI including calling party information is shown in below.

```
Alert With Information Message
  Calling Party Number info record
  Number Type 2(National), Plan 1(ISDN)
  Presentation 0(Allowed), SI 3 (Network Provided)
  Number (length = 10): 0123456789
```

Also, a format of a WCI is shown in below.

```
Waiting Call Information Message(WCI)
  waiting call number info
  Number(Length = 10):0123456789
  RECORD_TYPE
```

As shown above, in the present invention, the WCI with the flash message including call state information is generated by adding information record type (RECORD_TYPE) based on IS-2000 spec as following table, wherein the information record type represents the flash message including call state information.

TABLE 1

| INFORMATION | RECORD | MESSAGE | | |
|---|---|---|---|---|
| RECORD | TYPE | TYPE | F-CSCH | F-DSCH |
| CALL WAITING | 00010100 | WCI | N | Y |
| NUMBER | | | | |

The Table. 1 shows that the WCI message cannot be sent in a forward-common signaling channel (F-CSCH) since a field of F-CSCH is N which represents NO. Contrary, the WCI message can be sent in a forward-dedicated signaling channel (F-DSCH) since a field of F-DSCH is Y which represents YES.

Furthermore, information of callers in call waiting state is shown in following table.

TABLE 2

| TYPE-SPECIFIC FIELD | BITS |
|---|---|
| NUMBER-TYPE | 3 |
| NUMBER-PLAN | 4 |
| P1 | 2 |
| RESERVED | 6 |

Referring to Table. 2, NUMBER_TYPE represents types of a telephone number such as a long-distance call, a mobile terminal number or a short-key number. NUMBER_PLAN represents an identification number of a service network provided to an integrated service digital network (ISDN) and a Telex, and P1 is an indicator representing a user's permission to display a telephone number. According to a value of P1, the mobile terminal decides to display the telephone number. That is, whole telephone number or a part of telephone number is displayed according to P1.

After receiving the flash message including the call state information with the WCI from the base station, the call state information is displayed to the mobile terminal at step S305. That is, whenever the call-selection button is activated by the user of the mobile terminal, the mobile terminal displays the call state information of the first caller who is currently connected to the user of the mobile terminal and the call state information of the second caller who is put into a waiting state.

After displaying the call state information, the mobile terminal determines whether the call-selection button is activated at step S303.

The preferred embodiment of the present invention is explained by using a situation that the user talks to the second caller and the first caller is in the waiting state. However, multiple callers may be in waiting state and the call state information can be generated and displayed when a caller in the waiting state is reconnected to the user of the mobile terminal by activating the call-selecting button.

As mentioned above, the mobile terminal receives the WCI and AWI from the base station and analyzes the flash message including call state information included in the WCI. Therefore, the present invention can provide detail information of callers who are currently maintaining call connection between the user and the callers to the user of the mobile terminal.

In a case of hang up a call connection in the waiting state, the mobile terminal can recognize disconnection by receiving Call End Information Message (CEIM) from the base station.

A format of a conventional CEIM is shown as follow.

```
Call End Information Message
  Call end Party number info record
    Number (length = 10):4082064830
    Call end info XXXX
```

As shown, the conventional CEIM includes a telephone number so the user of the mobile terminal can be noticed who is disconnected. After analyzing CEIM, the mobile terminal may generates a beep sound and displays the disconnected telephone number at the same time for noticing the user of the mobile terminal.

In the present invention, a call state information of callers in the waiting state is transmitted to the mobile terminal by adding new information record type representing the call state information of callers in the waiting state based on an IS-2000 spec into the conventional CEIM.

TABLE 3

| Information | Record Type | | | |
|---|---|---|---|---|
| Record | (binary) | Message Type | F-CSCH | F-DSCH |
| Call End | 00010101 | ECI | N | Y |
| Information | | | | |
| Message | | | | |

As shown, F-CSCH field is N and F-DSCH is Y which means the CEIM cannot be transmitted through Forward-common signaling channel (F-CSCH) and the CEIM can be transmitted through Forward-dedicated signaling channel (F-DSCH).

As mentioned above, the present invention can accurately analyze current state of call connections currently connected to the user of the mobile terminal which are in the call waiting state or the activate state by receiving the flash message including the call state information from the base station when the mobile terminal is connected to multiple callers at the same time.

The present application contains subject matter related to Korean patent application No. KR 2003-0087164, filed in the Korean patent office on Dec. 03, 2003, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

1. A method for managing to receive multiples calls from multiple mobile terminals used in a network terminal including a plurality of the mobile terminals and a base station, comprising the steps of:
a) connecting a first mobile terminal and a second mobile terminal as a first call connection;
b) determining whether there is a request for a second call connection from a third mobile terminal;
c) determining whether a call-selection button is activated when the second call connection is requested from the third mobile terminal and continuously maintaining the first call connection if the call connection button is not activated;
d) at the first mobile terminal, receiving a flash message having call state information from the base station when the call-selection button of the first mobile terminal is activated; and
e) at the first mobile terminal, providing information of mobile terminals currently connected to the first mobile terminal by analyzing the call state information and repeatedly performing the step c).

2. The method of claim 1, wherein the flash message is a waiting call information message (WCI) including telephone numbers of mobile terminals which are currently connected to the first mobile terminal.

3. The method of claim 2, wherein the WCI additionally includes information record type based on IS-2000 spec on as below table

| INFORMATION | RECORD | MESSAGE | | |
|---|---|---|---|---|
| RECORD | TYPE | TYPE | F-CSCH | F-DSCH |
| CALL WAITING | 00010100 | WCI | N | Y |
| NUMBER | | | | |

4. The method of claim 2, wherein the WCI includes information of caller connected to the first mobile terminal as below table.

| TYPE-SPECIFIC FIELD | BITS |
|---|---|
| NUMBER-TYPE | 3 |
| NUMBER-PLAN | 4 |
| P1 | 2 |
| RESERVED | 6 |

5. The method of claim 2, further comprising the steps of:
f) determining whether a call end information message (CEIM) is received or not, wherein the CEIM is message generated when a currently connected call is dropped; and
g) displaying information of the dropped call connected by analyzing the CEIM.

6. The method of claim 5, wherein the CEIM includes a telephone number of a mobile station which is disconnected.

7. The method of claim 6, wherein the CEIM additionally includes information record type based on IS-2000 spec on as below table.

| Information | Record Type | | | |
|---|---|---|---|---|
| Record | (binary) | Message Type | F-CSCH | F-DSCH |
| Call End | 00010101 | ECI | N | Y |
| Information | | | | |
| Message | | | | |

8. The method of claim 7, wherein the telephone number of the mobile terminal which is disconnected is displayed at a LCD of the first mobile terminal and a predetermined sound is played at the same time.

9. The method of claim 1, further comprising the step of: h) providing a flash message including call state information of the second call connection to a mobile terminal which is putted into a waiting state caused by the second call connection.

10. A method for managing multiple calls in a mobile terminal, the method comprising the steps of:
a) requesting a second call connection while a first call connection is established; and
b) receiving a call state information when the first call connection is transformed to the second call connection,
wherein the call state information is a plurality of call identification information about the first call connection and the second call connection.

11. The method of claim 10, wherein the call identification information includes mobile terminal numbers of the first call connection and the second call connection.

12. The method of claim 11, wherein the call state information is received as a form of a flash message.

13. The method of claim 10, further comprising the steps of:
c) receiving a call end information message (CEIM) when one of the first call connection and the second call connection is dropped,
wherein the CEIM is a plurality of call identification information of dropped call connection.

14. The method of claim 13, wherein the call identification information includes mobile terminal numbers of disconnected call connections.

15. The method of claim 14, wherein the CEIM is a format of a flash message.
